(19) United States
(12) Patent Application Publication
(10) Pub. No.: US 2010/0129033 A1
(43) Pub. Date: May 27, 2010

(54) PLUG FOR A HYBRID OPTICAL WAVEGUIDE AND ELECTRICAL CONDUCTOR ARRANGEMENT, AND METHOD FOR ITS PRODUCTION

(76) Inventor: Walter Zeller, Wettingen (CH)

Correspondence Address: George Pappas, 919 S. Harrison Street, Suite 300, Fort Wayne, IN, 46802, US

(21) Appl. No.: 12/451,309

(22) PCT Filed: May 8, 2008
(86) PCT No.: PCT/CH2008/000211

§ 371 Date: Jan. 25, 2010

(30) Foreign Application Priority Data
May 9, 2007 (CH) 752/07

(51) Int. Cl. G02B 6/36; G02B 6/00; G02B 6/42

(52) U.S. Cl. 385/78; 385/139; 264/1.26

(57) ABSTRACT

The invention is based on a hybrid plug which produces both optical waveguide connections and electrical connections to a corresponding mating plug. In order to avoid mutual spherical optical transfer parts with an air crossover between the optical waveguides and the paralleling ball parts, it is proposed that the plug has a mounting and centering part and a lens part with encapsulated lenses which are produced from same polymer material and are adhesively bounded to one another. They have common channels for the ferrules which are inserted into ferrule holders with the optical waveguides.

This application claims priority of PCT application PCT/CH2008/000211 having a priority date of May 9, 2007, the disclosure of which is incorporated herein by reference.

### TECHNICAL FIELD

The invention relates to a plug for a hybrid optical waveguide and electrical conductor arrangement. Furthermore, the invention relates to a corresponding production method.

### BACKGROUND OF THE INVENTION

For connecting electrical conductors, particularly single mode electrical conductors made of fibers, lens plugs are generally used. These are built up in such a manner that they take over the light at the fiber ends with an exit angle that is typical for the fiber, collimate the beam of light with a ball lens and transmit the beam to the medium. In this manner one ensures that the light beam exiting from the ball lens is parallel. The parallel beam is received with a correspondingly equipped plug and is focused back into the fiber of the second cable by means of a similar ball lens. For receiving the fiber a ferrule is used, i.e. a tube made of ceramic, plastic or metal, and the ball lenses are embedded into a metallic body with correspondingly accurate boreholes. The ferrules align the fibers in centered manner with the ball lens.

If now a hybrid plug shall be produced, the prior art from which this invention sets out teaches using commercially available contacts for the electrical connection.

This solution has turned out to be disadvantageous. As a matter of fact, the plug consists of numerous highly precise components that need to be assembled preferably by handcraft and need to be measured correspondingly. The three principal materials that are built in (ceramics, glass, metal) have different thermal expansion coefficients. For this reason, the requirements concerning the accuracy of the individual components and of the assembled plug are very high. Moreover, because the light beam changes medium several times, each surface needs to be provided with an antireflection coating for the corresponding optical wavelength.

### SUMMARY OF THE INVENTION

The object of the present invention is to provide an improved plug for a hybrid optical waveguide and electrical conductor arrangement.

The invention is achieved by a plug for a hybrid optical waveguide and electrical conductor arrangement. A hybrid cable that is provided at the center thereof with a tube in which electrical conductors are arranged preferably coaxially, further comprises a plurality of optical waveguides. With this cable, data can be transmitted by means of the optical waveguides, whereas electrical energy, but of course also data, can be transmitted by means of the electrical conductor. The plug according to the present invention is attached to such a cable. The features of the invention primarily result in providing a simple production of the lens part and, further, an essentially temperature independent behavior with excellent optical transmission values. The temperature dependence (expansion coefficient) will be the same due to the identity of the polymer materials used, although it can differ by up to about 0.1%. In general, the refractive index will not be exactly identical: in case of using a quartz for the fiber (refractive index 1.478) and with the adopted polymer (refractive index 1.500), the difference is about 1.5%. In particular, the provisions of the invention lead to the result that the demanding production of ball lenses from costly and poorly reproducible glass material can be avoided. Moreover, the high precision mechanical processing and the high precision assembling of the individual components can be avoided. The plug of the present invention has good optical characteristics. This also allows the plug contacts to have good electrical properties.

It is advantageous if the mounting and centering part is produced from the same base material, preferably by means of injection molding. However, the mounting and centering part does not require the property of being optically transmitting because it does not, by itself, comprise any optical elements.

In order to be connectable with a preferably similar mating plug, the lens part further comprises a centering borehole for receiving the centering pin of the mating plug, and such a centering pin is adhesively bonded into a further centering borehole.

Because the outer surface of the lens optionally forms a transition to air, it is advantageous that the lenses are optically coated on the sides thereof that are directed away from the ferrules.

A fixed plug with optical characteristics that do not change, e.g. upon a temperature change, is obtained if the mounting and centering part is connected to the lens part by means of adhesive bonding.

In order to allow for an easy electrical connection, both the lens part and also the mounting and centering part each comprise a central feedthrough for said electrical connection.

It is particularly advantageous to provide force elements, preferably springs, by means of which the ferrules arranged in ferrule holders can be pressed against the lenses at the sides thereof adjacent to the mounting and centering part, so that an optical light contact without air crossover is formed. In this way the undesirable air crossovers of the light in the plug are avoided in any case.

According to a second aspect of the present invention, a method for producing a plug of the previously mentioned type is proposed.

The aforementioned elements to be used according to the invention, as well as those claimed and described in the following exemplary embodiments, are not subject to any particular conditions by way of exclusion in terms of their size, shape, use of material and technical design, with the result that the selection criteria known in the respective field of application can be used unrestrictedly.

### BRIEF DESCRIPTION OF THE DRAWINGS

Further details, advantages and features of the subject of the present invention are obtained from the following description of the corresponding drawings, in which inventive plugs for a hybrid optical waveguide and electrical conductor arrangement are explained by way of example. In the drawings, there is shown in:

FIG. 1 a representation of the optical body of a plug, in a plan view;

FIG. 2 a sectional view of the optical body of the plug according to FIG. 1;

FIG. 3 a star-like cover for the optical body of the plug, in a plan view;

FIG. 4 a representation of the lens part of the optical body of the plug according to FIG. 1, in a sectional view;

FIG. 5 a representation of the electro contacting part of the plug according to FIG. 1, in a sectional view;

FIG. 6 a ferrule holder for use in the plug according to FIG. 1, in a sectional view; and

FIG. 7 a plug in a schematic representation with an empty centering borehole and a centering pin and a mating plug.

### DETAILED DESCRIPTION OF THE PREFERRED EMBODIMENTS

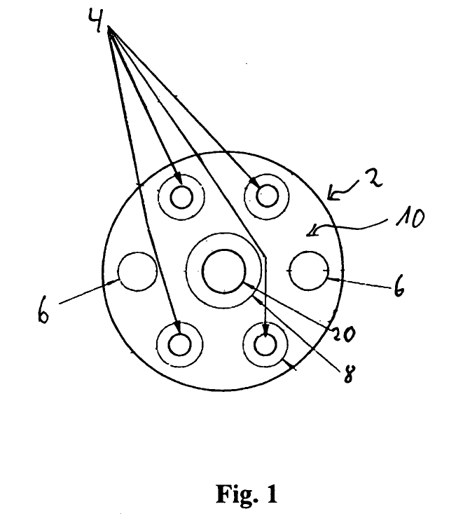

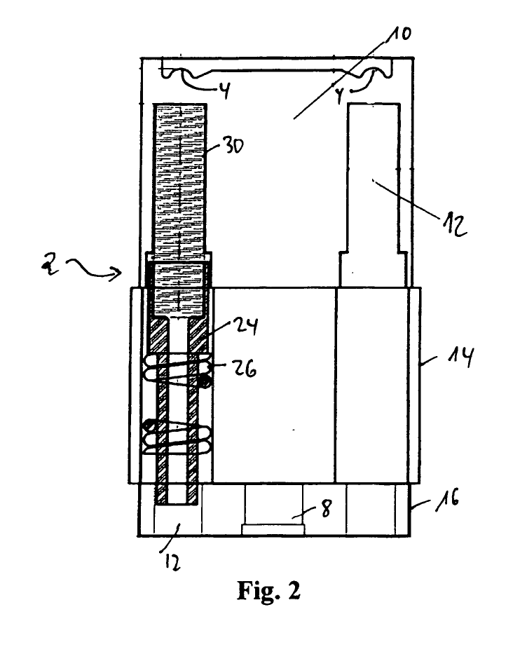

In FIGS. 1 and 2 a plug according to a preferred exemplary embodiment of the present invention is denoted in its entirety as 2. FIG. 1 shows, as a plan view from the “open” side of the plug, the lenses 4 of a lens part 10 as well as the centering boreholes 6 and an insertion opening 8 for the insert 20 for the electrical connections. In the present exemplary embodiment, the plug is round and it is configured substantially flat towards the open side thereof.

The overall view of the plug in the sectional view of FIG. 2 shows the three essential elements of the plug according to this exemplary embodiment, namely, the lens part 10 and the mounting and centering part 14, into which are provided channels 12 for the ferrules 30 that are arranged in the ferrule holders 24. In the lens part 10, the channels 12 end directly below the lenses 4 so that the lenses 4 are configured as a transition between the channels 12 and the plug surface.

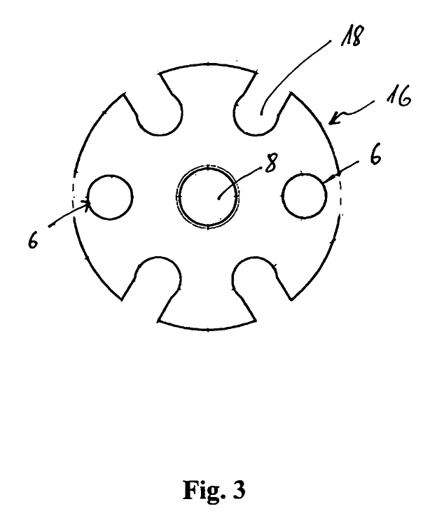

A further element of the plug is the star-like cover 16 (FIG. 3), in which are provided recesses 18 as a passage for the ferrule 30 and the optical waveguides, respectively, and a centering borehole 6 and a recess 19 for the insert 20 for the electrical connections.

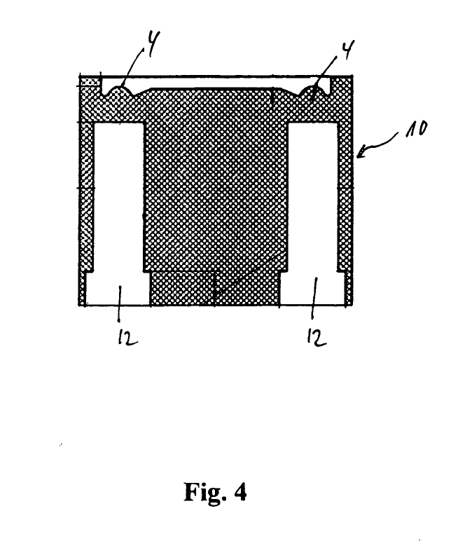

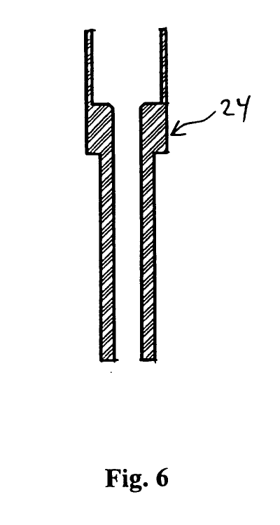

FIG. 4 shows the lens part 10 as a sectional view in detail. The ferrule 30 in the ferrule holders 24 (FIG. 6) fit exactly into the channels 12.

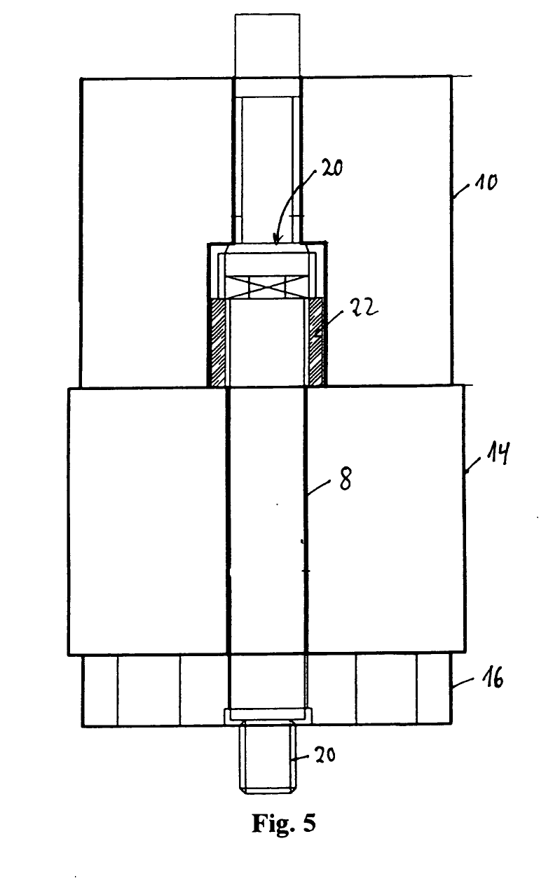

The electrical connection of the preferred exemplary embodiment is evident from FIG. 5. An insertion opening 8 for the insert 20 for the electrical connection extends through the lens part 10, the mounting and centering part 14 and the star-like cover 16. Said insert is formed as a conventional electrocontact—in the present example as an “IGUN flat contact” (HSS 120 230 A 3002 M 24 A). The “IGUN” sleeve 22 (KS 113 30 M2) has been shortened to 13 mm.

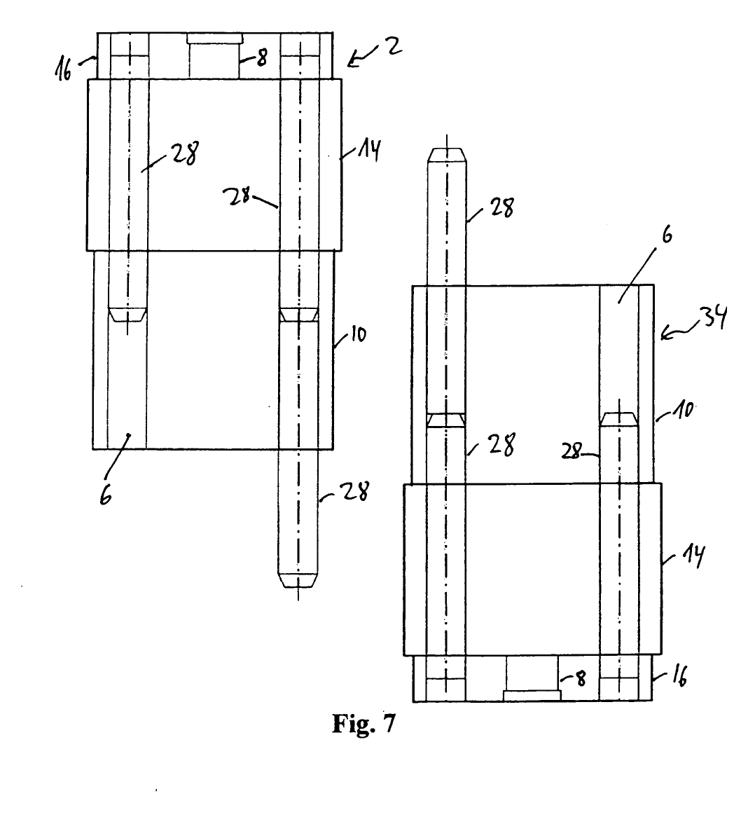

In the present exemplary embodiment it is intended that the entire plug is inserted into a metal sleeve that also serves as a second electrical pole (mass pole) for the electrical connection. This sleeve is not shown here and does not have any peculiarities with regard to the present invention. As shown in FIG. 7, the positioning in respect to a corresponding mating plug 34, which in the present example is formed similarly, is achieved by the coupling of the centering boreholes and the centering pins 28.

In the present exemplary embodiment, the plug is produced by individual injection molding of the lens part 10 from a transparent polymer, which in this case is a material that is commercially available under the trade name Topas® (Cycloolefin Copolymer from Ticona/Celenese), in such a manner that the lenses 4 are formed with the requisite shape upon injection molding. Thereafter, the mounting and centering part 14 is injection molded from the same base material, albeit in an opaque version. Into these two injection molded parts, centering pins 28 are first inserted into the corresponding centering boreholes 6 until the lens part 10 and the mounting and centering part 14 are positioned in an accurately fitting mode with respect to each other. Then, these two parts are glued together. The ferrule holders 24 are inserted into the channels 12 for the ferrules 30, and, furthermore, the ferrules 30 are inserted into the insertion opening 8 of the electrical insert 20, and the star-like cover 16 is placed upon and connected with the mounting and centering part 14, for example by adhesive bonding or by screwing. By means of pressure springs 26 the ferrule holders 24 and correspondingly the ferrules 30, and, finally, the optical waveguides are pressed against the lower side of the lenses 4. Thereby, an optical connection without air crossover is formed between the optical waveguide and the lower side of the lens 4. The surfaces of the lenses 4 are optically coated according to the intended wavelengths of the respective lightwaves that are to be guided through the optical waveguides.

### LIST OF REFERENCE NUMERALS

2 plug
4 injection molded lens
6 centering borehole
8 insertion opening for electrical connections
10 lens part
12 channel for ferrule
14 mounting and centering part
16 star-like cover
18 recess
20 insert for electrical connections
22 distance sleeve
24 ferrule holder
26 pressure spring
28 centering pin
30 ferrule
32 electrocontact element
34 mating plug

1. A plug for a hybrid optical waveguide and electrical conductor arrangement, wherein the ends of the optical waveguides are arranged in ferrules, comprising optical and electrical connection elements and a mounting and centering part that receives therein the connection elements, wherein the carrier material of the mounting and centering part is electrically non-conductive, characterized in that:
the plug comprises a lens part with optical connection elements, namely lenses,
wherein the lens part together with the optical lenses are formed from an optically transmitting material,
in the mounting and centering part as well as in the lens part there are formed boreholes for receiving therein the ferrules into which are inserted the ends of the optical waveguides,
certain optical characteristics of the carrier material correspond at least substantially to the optical characteristics of the optical waveguides, these optical characteristics comprising at least the refractive index, which may differ by maximally 5%, preferably by maximally 1.5%,
certain mechanical characteristics of the carrier material correspond at least substantially to the mechanical characteristics of the lens part, these mechanical characteristics comprising at least the thermal expansion coefficient, which can differ by maximally 1%, preferably by maximally 0.1%,
the mounting and centering part has been formed by injection molding,
the lens part further comprises at least one centering borehole for receiving therein at least one centering element, particularly a centering pin of a mating plug, and
the lens part comprises at least one centering pin that can be received in a centering borehole of a mating plug.

2. The plug according to claim 1, characterized in that the mounting and centering part is formed of the same base material as the lens part, the base material of the mounting and centering part preferably being optically non-transmitting.

3. The plug according to claim 1, characterized in that the optical lenses are optically coated on the sides thereof that are directed away from the ferrules.

4. The plug according to claim 1, characterized in that the mounting and centering part is connected to the lens part by means of adhesive bonding.

5. The plug according to claim 1, characterized in that the lens part and the mounting and centering part each comprise a central feedthrough for said electrical connection.

6. The plug according to claim 1, characterized in comprising force elements, in the form of springs, by means of which the ferrules arranged in ferrule holders can be pressed against the lenses at the sides thereof adjacent to the mounting and centering part, thereby forming an optical light contact without air crossover.

7. A method for producing a plug according to claim 1, characterized by the steps:
injection molding of the mounting and centering part, injection molding of the lens part,
wherein boreholes for receiving therein the ferrule, and openings for the electrical connection elements are formed in the mounting and centering part and in the lens part, and wherein centering boreholes are formed in the lens part and in the mounting and centering part,
connecting the mounting and centering part with the lens part by means of adhesive bonding or a similar connecting method.

8. The method of claim 7, characterized by the further step of receiving the ferrules in the boreholes by means of ferrule holders.

9. The method according to claim 8, characterized by the further step of attaching a star-like cover, whereby spring elements in the form of pressure springs, are urged against the ferrule holders in such a manner as to press the optical waveguides in the ferrules against the lenses in the lens part, thereby forming an optical light contact without air crossover.

10. The method according to claim 7, characterized by the further step of optically coating the exposed surfaces of the lenses.

11. The method according to claim 8, characterized by the further step of optically coating the exposed surfaces of the lenses.

12. The method according to claim 9, characterized by the further step of optically coating the exposed surfaces of the lenses.

13. The plug according to claim 2, characterized in that the optical lenses are optically coated on the sides thereof that are directed away from the ferrules.

14. The plug according to claim 2, characterized in that the mounting and centering part is connected to the lens part by means of adhesive bonding.

15. The plug according to claim 3, characterized in that the mounting and centering part is connected to the lens part by means of adhesive bonding.

16. The plug according to claim 2, characterized in that the lens part and the mounting and centering part each comprise a central feedthrough for said electrical connection.

17. The plug according to claim 3, characterized in that the lens part and the mounting and centering part each comprise a central feedthrough for said electrical connection.

18. The plug according to claim 4, characterized in that the lens part and the mounting and centering part each comprise a central feedthrough for said electrical connection.

19. The plug according to claim 2, characterized in comprising force elements, in the form of springs, by means of which the ferrules arranged in ferrule holders can be pressed against the lenses at the sides thereof adjacent to the mounting and centering part, thereby forming an optical light contact without air crossover.

20. The plug according to claim 3, characterized in comprising force elements, in the form of springs, by means of which the ferrules arranged in ferrule holders can be pressed against the lenses at the sides thereof adjacent to the mounting and centering part, thereby forming an optical light contact without air crossover.

21. The plug according to claim 4, characterized in comprising force elements, in the form of springs, by means of which the ferrules arranged in ferrule holders can be pressed against the lenses at the sides thereof adjacent to the mounting and centering part, thereby forming an optical light contact without air crossover.

22. The plug according to claim 5, characterized in comprising force elements, in the form of springs, by means of which the ferrules arranged in ferrule holders can be pressed against the lenses at the sides thereof adjacent to the mounting and centering part, thereby forming an optical light contact without air crossover.
